(19) United States
(12) Patent Application Publication
(10) Pub. No.: US 2021/0067760 A1
(43) Pub. Date: Mar. 4, 2021

(54) STEREOSCOPIC DISPLAY METHOD AND SYSTEM FOR DISPLAYING ONLINE OBJECT

(71) Applicant: Lixel Inc., Taipei City (TW)

(72) Inventors: CHUN-HSIANG YANG, Hsinchu City (TW); KAI-CHIEH CHANG, Kaohsiung City (TW); CHIH-HUNG TING, New Taipei City (TW); YU-CHIANG HSU, Tainan City (TW)

(21) Appl. No.: 16/556,239

(22) Filed: Aug. 30, 2019

(51) Int. Cl. H04N 13/194; H04N 13/167; G06F 17/21; G06F 16/53; G06Q 30/02

(52) U.S. Cl. CPC H04N 13/194; H04N 13/167; G06Q 30/0277; G06F 16/53; G06F 17/212

(57) ABSTRACT

A stereoscopic display method and a system for displaying an online object are provided. The system provides a stereoscopic image server and a user-end stereoscopic image display. When a user browses a content website, the website provides a flat image to a user device, and a content server also generates a request for displaying an object. The stereoscopic image server generates a stereoscopic image data corresponding to the object according to the request. The stereoscopic image data can be obtained by querying an image database, or by calculation using a stereoscopic image resource file. The stereoscopic image data is provided for the stereoscopic image display to display a stereoscopic image. Alternatively, the stereoscopic image data can be generated by the user-end stereoscopic image display when it receives the stereoscopic image resource file from the server.

### FIELD OF THE DISCLOSURE

The disclosure is related to a technology for displaying an online object, and more particularly to a stereoscopic display method that converts the online object into a three-dimensional image and a system for the same.

### BACKGROUND OF THE DISCLOSURE

Online content is generally shown on a terminal device via a web page browser. The terminal device includes a flat display that is used to display the online content in a flat format. Nonetheless, it is possible to display the online content via a stereoscopic image if the stereoscopic image is formed in advance by stitching together pictures taken by a camera at different angles of the online content.

For example, when using a camera to capture several pictures of an article at different angles and stitching the pictures together for forming a stereoscopic image, the article can be such as merchandise, a piece of art or a building that can be viewed by a user at different angles of view.

Further, a three-dimensional (3D) model of the article can also be created firstly, and then texture images are appended to the 3D model so as to form the stereoscopic image of the article. Therefore, the user can view the article from various angles through a corresponding software program.

### SUMMARY OF THE DISCLOSURE

The disclosure is generally related to a stereoscopic display method and a system thereof for displaying an online object. The stereoscopic display method for displaying the online object is implemented by the system and is provided for a user to browse articles exhibited on a content website using the stereoscopic images of the articles. For example, the system provides stereoscopic images of products, advertisements, or the objects as the stereoscopic images in an E-commerce platform that allows the user to view the online content using stereoscopic images.

According to an embodiment of the stereoscopic display method of the disclosure, the method is applied to a system that provides a stereoscopic image server. The stereoscopic image server receives a request for displaying an object from a content server. The request is a request for displaying a moving object or a static object. A requesting source can be obtained from the request. In the stereoscopic image server, a stereoscopic image data with respect to the object is generated and transmitted to a stereoscopic image display for displaying a stereoscopic image according to the requesting source.

In a preferred embodiment, when the stereoscopic image server receives a request for displaying the object, an image database is queried with an identification data carried by the request for obtaining a stereoscopic image data corresponding to an object. In an example, the stereoscopic image data is data that allows a stereoscopic image display to directly display a stereoscopic image.

In another preferred embodiment, when the stereoscopic image server receives a request for displaying the object from a content server, the image database is also queried with the identification data of an object. The stereoscopic image data can be a stereoscopic image resource file corresponding to the object. The stereoscopic image resource file is provided for the stereoscopic image display to calculate a stereoscopic image of the object.

In one further embodiment of the disclosure, when the stereoscopic image server receives a request for displaying the object, the stereoscopic image server also receives a stereoscopic image resource file of the object from the content server. A processor of the stereoscopic image server can calculate a stereoscopic image data with respect to the object using the stereoscopic image resource file in real time. The stereoscopic image data is data that is provided for the stereoscopic image display to directly display the stereoscopic image.

In another aspect of the disclosure, the object can be a product exhibited on a web page. After activating a link with respect to the object, the content server transmits the request for the display object to the stereoscopic image server.

In one further aspect, the object can be an advertisement shown on the web page. A link with respect to the advertisement is activated when the web page is browsed. The link enables the content server to transmit the request for displaying the object to the stereoscopic image server.

### BRIEF DESCRIPTION OF THE DRAWINGS

The present disclosure will become more fully understood from the following detailed description and accompanying drawings.

FIG. 1 is a schematic diagram depicting a network framework of the stereoscopic display system according an embodiment of the disclosure;

FIG. 2 shows a flow chart describing the stereoscopic display method in one embodiment of the disclosure;

FIG. 3 shows a flow chart describing the stereoscopic display method in another embodiment of the disclosure;

FIG. 4 shows a flow chart describing the stereoscopic display method in one further embodiment of the disclosure; and

FIGS. 5 through 8 show flow charts describing the stereoscopic display method that is operated among a flat display element, a stereoscopic image display element, a content server and a stereoscopic image server according to the embodiments of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The disclosure is generally related to a stereoscopic display method and a system for displaying an online object. In the stereoscopic display method, in response to a user's browsing activity, a stereoscopic image data is formed and is provided for a user-end display to display a related stereoscopic image that achieves an extraordinary viewing experience.

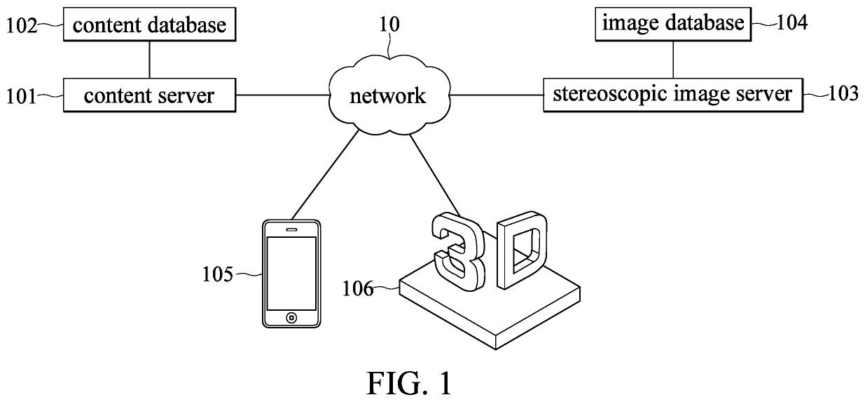

Reference is made to FIG. 1 that shows a schematic diagram of a network framework of a system for displaying an online object in one embodiment of the disclosure. In the embodiment, the stereoscopic display system provides a stereoscopic image server 103 that provides or produces a stereoscopic image data corresponding to an object in response to a user's request or a demand of a content provider. The aforementioned stereoscopic image can be a static object or a series of stereoscopic images of a moving object. The stereoscopic image server 103 includes an image database 104 that stores a plurality of stereoscopic image data being created in a specific format. The stereoscopic image server 103 can instantly provide a stereoscopic image data according to a request. For example, the stereoscopic image data is provided for a user-end stereoscopic image display 106 to display the stereoscopic image.

In one further embodiment, the stereoscopic image server 103 has the capability of computing a stereoscopic image in real time. The stereoscopic image server 103 provides information of the stereoscopic image according the requirement made by the user, and the information recorded in a stereoscopic image resource file includes the information of color and three-dimensional space relating to the stereoscopic image. The stereoscopic image resource file is used to depict a static stereoscopic image or a stereoscopic video and is provided for the server 103 to calculate stereoscopic image in real time. The stereoscopic image is then transmitted to the stereoscopic image display 106 for displaying the image.

In one further embodiment, the stereoscopic image server 103 can work with a content server 101 for providing the stereoscopic image. The content server 101 can be an E-commerce platform, a knowledge library, a search engine, a social media, or a news website that has a content database 102 for storing various data of objects. The content server 101 provides a text, a picture or a video, and also a service for displaying the object in a stereoscopic image. For example, the content database 102 of the E-commerce platform records the images or texts about the products exhibited in a shopping website. The content database 102 of the knowledge library records web pages, blogs, news, pictures and videos. The content database 102 of the social media records the texts, pictures or videos shared or reposted in the social media.

The content server 101 links to the stereoscopic image server 103 via a network 10. When any requirement for displaying the stereoscopic image with respect to an object is produced, the content server 101 transmits a request to the stereoscopic image server 103 according to a user's requirement. The stereoscopic image server 103 then provides the stereoscopic image data from the image database 104 or calculates the stereoscopic image in real time in response to the request.

A stereoscopic image is finally displayed on the user-end stereoscopic image display 106. In the present embodiment, a user-end computer is provided. The computer is such as a user device 105 that is equipped with the stereoscopic image display 106. The user device 105 is provided for a user to browse content in the content server 101. When producing a request for a stereoscopic image, the stereoscopic image data can be obtained from the stereoscopic image server 103. The stereoscopic image data is provided for the stereoscopic image display 106 to display the stereoscopic image. Alternatively, the user can directly manipulate the stereoscopic image display 106 to browse the content in the content server 101. For example, the content can be displayed on the stereoscopic image display 106 in a flat image mode or in a stereoscopic image mode.

In an exemplary example, the user-end stereoscopic image display 106 can be a standalone computer device that is used to browse content of the content server 101. The computer device can be disposed with a stereoscopic display module and a flat display module that may require dual screens. Alternatively, the computer device may also work with another computer device for displaying the stereoscopic image. The computer device can be a personal computer or a mobile device. In one aspect of the disclosure, the stereoscopic display system in one of embodiments of the disclosure adopts a display device that uses a screen to be divided into two separate displays for displaying both a flat image and a stereoscopic image. In one further aspect of the disclosure, a specific display panel with dual display function in the computer device can be switched to a flat display function or a stereoscopic display function. According to one embodiment of the disclosure, the user-end device or the stereoscopic image display 106 may include an input device such as a computer mouse, a keypad, or a sensor that is capable of sensing gestures that allow the user to control the content to be browsed.

It should be noted that the stereoscopic display technology of the stereoscopic display system for displaying the online object can still adopt the conventional technology that uses special glasses such as red-cyan glasses, polarized glasses, or shutter glasses to view the stereoscopic image. Further, stereoscopic display technology can be a floating stereoscopic display technology that utilizes a lens array to display a floating image within a distance from a flat display. The stereoscopic image is formed based on color information and three-dimensional spatial information of the image. The three-dimensional spatial information includes a flat image data and a depth map. Further, the three-dimensional spatial information may include three-dimensional coordinates and chromatic values. The stereoscopic image is finally produced based on a relative spatial relationship between the display, the optical elements, e.g. the lens array, and the segmented images.

In one embodiment, the content server 101 and the stereoscopic image server 103 are connected via the network 10. The content server 101 may provide the stereoscopic images since the stereoscopic image server 103 can be built in the content server 101 as software modules for implementing the stereoscopic display technology.

In one further embodiment, the stereoscopic image server 103 can operate as a cloud server that provides a cloud service that links a plurality of servers for providing various contents. The cloud server provides the stereoscopic image data in response to terminal requirements. The stereoscopic image data can be a static stereoscopic image or a stereoscopic video formed by a series of images. The stereoscopic image data is provided by the image database 104 of the stereoscopic image server 103. In one further aspect, a stereoscopic image resource file used for calculating the stereoscopic image can be provided by a server, and the stereoscopic image resource file is calculated in real time by a processor of the stereoscopic image server 103 in order to obtain a stereoscopic image data. The stereoscopic image data is then provided for the stereoscopic image display 106 to display the stereoscopic image. Further, the stereoscopic image display 106 can calculate the stereoscopic image by its own processor when receiving the stereoscopic image resource file.

The following process describes the stereoscopic display method for displaying an online object according to one embodiment of the disclosure. A user uses a user device, e.g. a personal computer or a mobile device, to browse a content website, and uses a stereoscopic image display to view a stereoscopic image. The user device and the stereoscopic image display can be two individual electronic devices, and can also be one circuit module that integrates a flat display and a stereoscopic display. Further, the display of the user device can be a display panel on which a flat display panel and a stereoscopic display panel are manufactured. Still further, the display panel of the user device can also be one panel that is switched to activate a flat display element or a stereoscopic display element. In other words, the flat display element and the stereoscopic display element can be two individual devices that are responsible for displaying a flat image and a stereoscopic image, respectively, and can be integrated into one device.

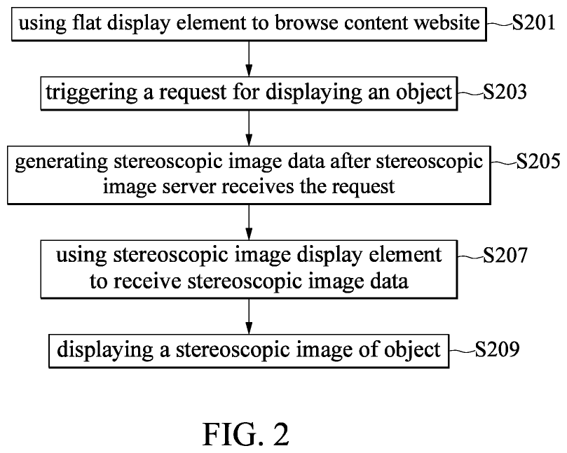

FIG. 2 shows a flow chart that describes a stereoscopic display method for displaying an online object in one embodiment of the disclosure.

In the beginning, such as in step S201, a user manipulates a flat display element of a user device to browse a content website. For example, the user device is used to search information on a search engine website, browse and shop on an E-commerce platform, or view content such as texts, pictures or videos on a web page.

In the meantime, such as in step S203, a software program embedded in the content web page of the website can activate a command to generate a request for displaying an object in response to a user's manipulation. In step S205, the request for displaying the object is transmitted to a stereoscopic image server. The stereoscopic image server generates a stereoscopic image data corresponding to the object after receiving the request.

Since the request may include the information that can be used to identify the user, a requesting source with respect to the object is obtained. The information used to identify the user is such as a network address (IP), a Media Access Control (MAC) or a user ID. In step S207, the stereoscopic image server transmits a stereoscopic image data to a user-end stereoscopic image display element via a network or with a specific transmission path according to the requesting source. After the stereoscopic image data is received, such as in step S209, the stereoscopic image display element displays the stereoscopic image with respect to the object.

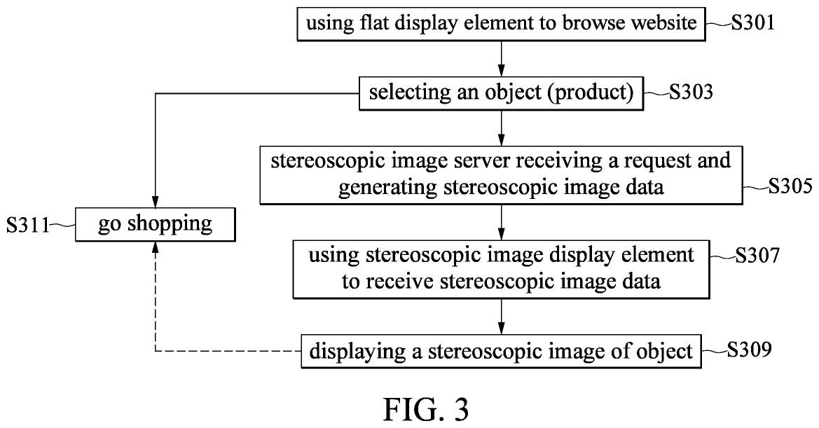

FIG. 3 shows one further flow chart for describing the stereoscopic display method in one embodiment of the disclosure.

In step S301, a user uses a flat display element of a computer device to browse a content website. In step S303, the user manipulates the computer device to select an object, e.g. a product exhibited on a web page of an E-commerce platform. In the meantime, a link with respect to the object is activated in response to the user's selection. The user can either directly proceed with shopping on the E-commerce platform (step S311), or, alternatively, the content server generates a request for displaying object corresponding to the object (step S305). When a stereoscopic image server receives the request, an image database is queried according to information of the object for providing a stereoscopic image data or calculating a stereoscopic image data.

In step S307, the stereoscopic image server transmits the stereoscopic image data to a specified user-end stereoscopic image display element according to a requesting source acquired from the request. In step S309, the stereoscopic image display element displays the stereoscopic image of the object.

In one embodiment of the disclosure, the user can activate a shopping procedure using a computer device when deciding to purchase a product after viewing the stereoscopic image of the product (step S311). In one further embodiment of the disclosure, the stereoscopic image display element can be a standalone device that allows the user to link to the content server for shopping.

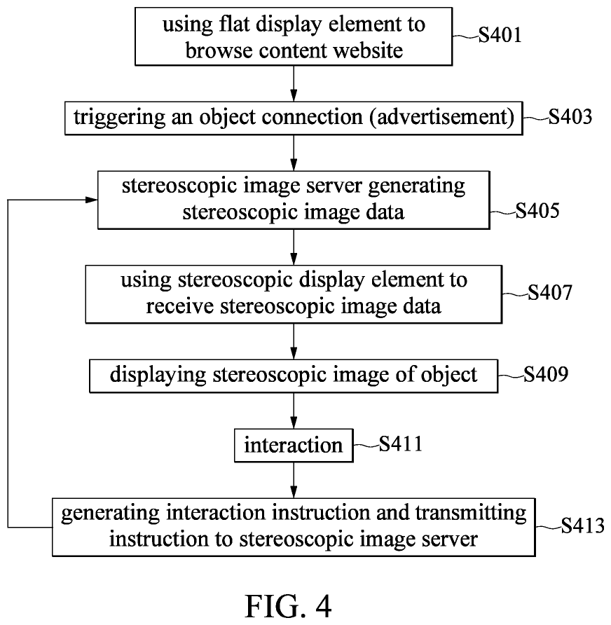

Reference is made to FIG. 4 that shows a flow chart describing a stereoscopic display method for displaying an online object in one embodiment of the disclosure.

In step S401, a user uses a flat display element of a computer device to browse content on a content website that can be served by a content server. Not only does the user browse the content, but also, such as in step S403, a software procedure initiated in a background process running with the web page activates a link for the object. The link is such as a URL with respect to an advertisement embedded in the web page. In the meantime, such as in step S405, the content server transmits a request for displaying the object to a stereoscopic image server in response to activating of the link. The stereoscopic image server is accordingly used to transmit a stereoscopic image data to a user-end stereoscopic image display element according to a requesting source retrieved from the request.

In step S407, the user-end stereoscopic image display element receives the stereoscopic image data. In step S409, a stereoscopic image is then displayed. In the meantime, such as in step S411, the user manipulates the stereoscopic image by an interactive function of the stereoscopic image display element. In step S413, the stereoscopic image display element then generates signals in response to the interaction by a gesture in order to generate an interaction instruction. The interaction instruction records changes of the image corresponding to the interactive gesture. The interaction instruction can be sensed by a sensor. After that, the interaction instruction is then transmitted to the stereoscopic image server.

At this moment, the steps S405 through S409 are repeated. The stereoscopic image server determines another display mode of the stereoscopic image according to the image information recorded in the interaction instruction. The next mode of stereoscopic image data is therefore produced. The stereoscopic image data can be obtained by querying the image database, or can be calculated in real time. Similarly, the stereoscopic image data is also transmitted to the user-end stereoscopic image display element for displaying the new stereoscopic image in response to the interaction instruction.

It should be noted that, when the stereoscopic image display element displays the stereoscopic image with respect to the object, the stereoscopic display system allows the user to perform interaction thereon by a gesture or a specific input method. For example, a gesture sensor can be disposed with the stereoscopic image display element for sensing the user's gesture such as one or any combination of movement, rotation and resizing. The interaction instruction is then transmitted to the stereoscopic image server and a software tool uses the interaction instruction to obtain the three-dimensional coordinates and vectors corresponding to a display space for generating a new stereoscopic image data.

Furthermore, when the stereoscopic image is displayed, it may act as a floating stereoscopic image, and the stereoscopic image display element should obtain every position of every pixel of the stereoscopic image. The positions with respect to the pixels show the light spots over the three-dimensional coordinates. The interaction made by the user's gesture performed upon the stereoscopic image can be sensed by the sensor as lights, acoustic waves or images. The system can obtain the spatial positions of the gestures of the fingers, palm and knuckles in response to the interaction. The software procedure running in the stereoscopic image display element can determine the movement, rotation and resizing performed on the stereoscopic image. The stereoscopic image server provides the stereoscopic image data in response to the interaction. Under a high-speed transmission and calculation, the user can experience a fast response of the stereoscopic image produced by the server based on his manipulation. Therefore, the stereoscopic display system allows the user to instantly view the object, e.g. a product or an advertisement, at different angles of view.

Further, the interaction performed by the user may be, but is not limited to, hand gestures, sounds or touch commands that can be sensed by specific sensors. Other input methods for contributing to the interaction may also be used. The input methods are such as gestures performed on a touch panel, face tracking, eye-gaze tracking, and remote software control that may cooperate with various sensors, e.g. light sensors or gyroscopes, and communication technologies such as Bluetooth® or RFID.

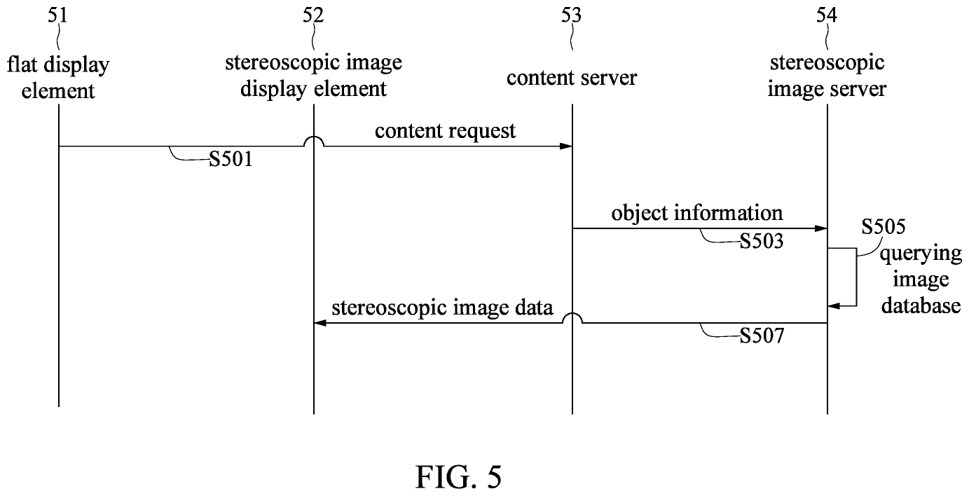

FIGS. 5 through 8 show flow charts describing the stereoscopic display method that is operated among a flat display element, a stereoscopic image display element, a content server and a stereoscopic image server according to the embodiments of the disclosure.

The above-mentioned flat display element 51 can be implemented as a flat display module disposed in a user device, or a standalone device. The stereoscopic image display element 52 can also be implemented as a stereoscopic display module in the user device, or another standalone stereoscopic image display. The content server 53 can be a general web site, an audio/video content server, an E-commerce platform, or a search engine based on the various aspects of the invention. The stereoscopic image server 54 implements a content platform that can be a standalone server, or a software process and/or hardware for processing the image data inside the content server 53.

### Embodiment 1

FIG. 5 shows a flow chart describing the stereoscopic display method in one embodiment of the disclosure. In the present embodiment, the content server 53 can be a general web server or an audio/video content server.

In the beginning, a user manipulates a flat display element 51 of a computer device to generate a request for a content server 53, and the request is for browsing the content of the content server 53 (step S501). The user can select an object of interest or initiate a play command to a specific object while browsing the content. The content server 53 generates information such as identification data (ID) relating to the object in response to the selection. The content server 53 then generates a request for displaying the object, and the request with the information of the object is transmitted to a stereoscopic image server 54 (step S503). A software process operated in the stereoscopic image server 54 queries an image database according to the identification data (step S505) for obtaining a stereoscopic image data with respect to the object. The stereoscopic image data can be the image data that is calculated and converted in advance in the server 54. The stereoscopic image data is then transmitted to a user-end stereoscopic image display element 52 (step S507). The stereoscopic image display element 52 decodes the data and displays a stereoscopic image in a specific format.

### Embodiment 2

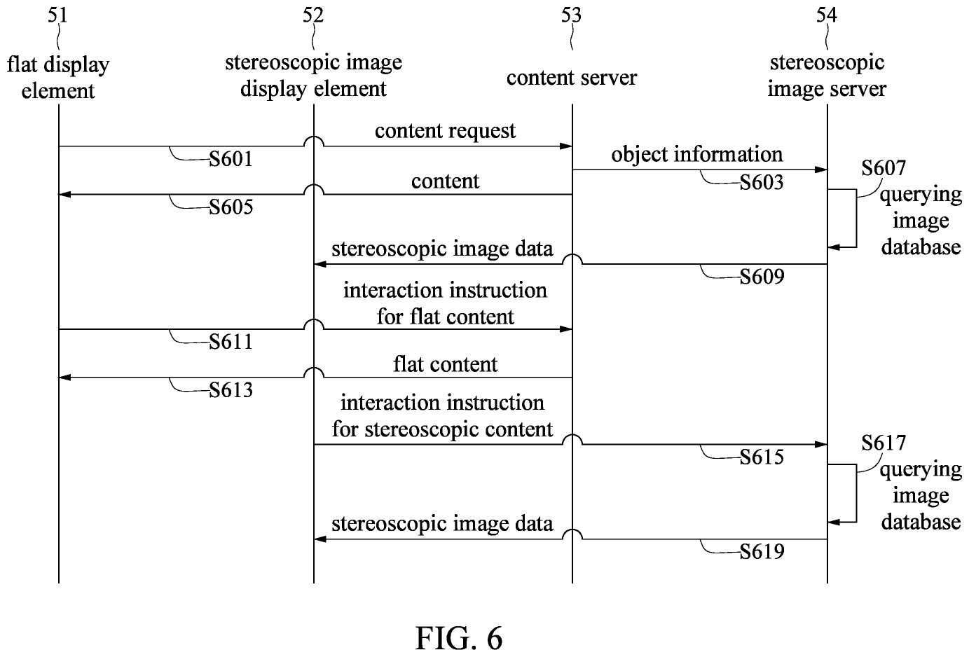

In FIG. 6, the content server 53 can be a content website that provides texts, pictures and/or audios/videos.

As the user manipulates the user device, the flat display element 51 transmits a request for the content server 53 (step S601). The request can be about browsing the content of the content server 53 so as to select an object of interest. In the meantime, the content server 53 generates a request for displaying the object in response to the selection. The request with an identification data with respect to the object is transmitted to the stereoscopic image server 54 (step S603). On the other hand, the stereoscopic image server 54 responds to the user's request that records a requesting source for providing the corresponding content (step S605). The current content may still be a flat content that can be processed by the flat display element 51.

In the stereoscopic image server 54, the image database is queried according to the object information (step S607). A stereoscopic image data with respect to the object is produced. After relevant preparation procedures, e.g. encryption and encoding, the stereoscopic image data is transmitted to the user-end stereoscopic image display element 52 (step S609). The stereoscopic image display element 52 can display the stereoscopic image after decoding the image data.

At the user-end, the flat display element 51 displays the flat content provided by the content server 53, and the stereoscopic image display element 52 displays the stereoscopic image. The dual display mode provides the user with different viewing experiences of the content.

The user can utilize some input peripherals such as a computer mouse, a keypad, a touch panel and a sound device to perform interaction to the content provided by the content server 53. An interaction instruction for flat content is generated and transmitted to the content server 53 (step S611). The content server 53 firstly provides a flat content in response to an interaction instruction to the flat display element 51 (step S613).

The user manipulates the stereoscopic image display element 52 through any of the mentioned input methods. The user can perform interaction upon the stereoscopic image by gesture. An interaction instruction for stereoscopic content is generated and transmitted to the stereoscopic image server 54 (step S615). The software process operated in the stereoscopic image server 54 determines another display mode according to the interaction instruction. After querying the image database (step S617), another stereoscopic image data is directly provided, or is calculated in real time. The stereoscopic image data is then transmitted to the stereoscopic image display element 52 (step S619). The stereoscopic image display element 52 is used to display the stereoscopic image in response to the interaction instruction. The interaction can be a series of actions. Therefore, the stereoscopic image server 54 may constantly provide the series of stereoscopic image data for providing a special viewing experience.

### Embodiment 3

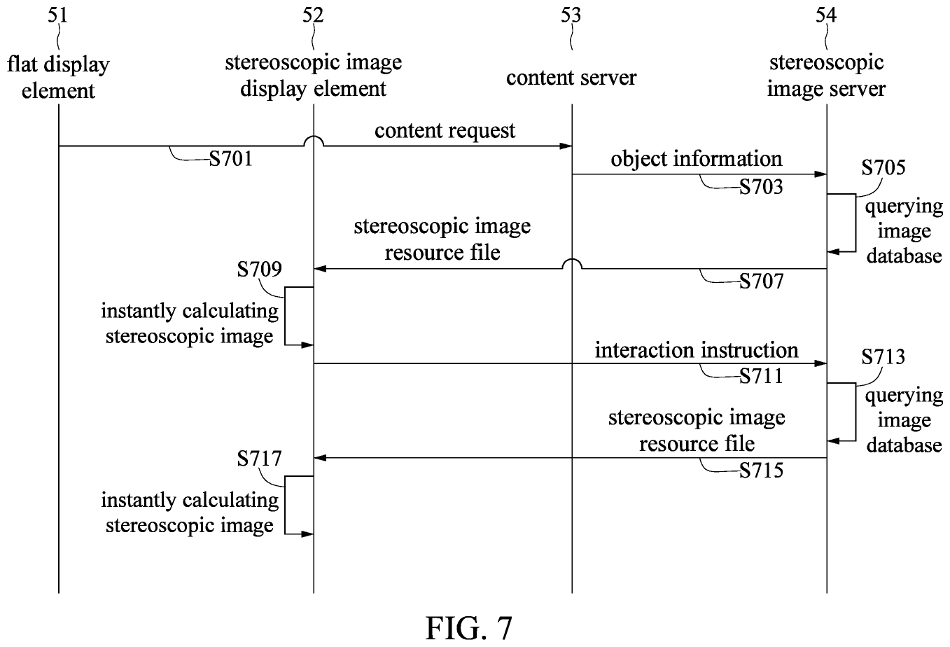

FIG. 7 shows one further schematic diagram used to depict the stereoscopic display system in one further embodiment of the disclosure. In the present embodiment, the content server 53 can be a general content website that forms an E-commerce platform, and the objects can be the products of interest or the embedded advertisements on the platform. Further, the objects can also be the content being produced in the stereoscopic image server 54 through an activation action. The image database of the stereoscopic image server 54 stores the stereoscopic image resource files with respect to the various objects. The stereoscopic image resource file is used to record the requisite information for calculating the stereoscopic image. For example, the stereoscopic image resource file includes a stereoscopic image description file and an environmental data file, and in which the stereoscopic image description file describes the three-dimensional coordinates, vectors and size relating to an object, and the environmental data file describes the environmental light, angle of view, texture and color relating to the object. The object can be a static object or a moving object.

In the beginning, the user manipulates the flat display element 51 to send a request for browsing the content to the content server 53 (step S701). The user can select an object of interest on a web page. Alternatively, an object can be automatically activated when the user browses the web page. The information of the object is transmitted to the stereoscopic image server 54 (step S703). A software process operated in the stereoscopic image server 54 queries the image database according to the object information (step S705). A stereoscopic image resource file can be obtained. In one aspect, the stereoscopic image resource file is transmitted to the user-end stereoscopic image display element 52 (step S707). The stereoscopic image display element 52 itself or a processor of another device can calculate a stereoscopic image in real time based on the data recorded in the stereoscopic image resource file (step S709). The stereoscopic image can be displayed instantly.

At this moment, the stereoscopic image display element 52 allows the user to manipulate the stereoscopic image by his gesture. An interaction instruction is generated and sent to the stereoscopic image server 54 (step S711). A software process operated in the stereoscopic image server 54 determines another display mode of the object according to the interaction instruction. After querying the image database (step S713), a new stereoscopic image resource file can be obtained. The new stereoscopic image resource file is also transmitted to the stereoscopic image display element 52 (step S715). The stereoscopic image display element 52 calculates a stereoscopic image using the new stereoscopic image resource file (step S717).

If the interaction is made by continuous actions, a series of interaction instructions are continuously generated. The interaction instructions are also continuously transmitted to the stereoscopic image server 54. In the stereoscopic image server 54, the image data is queried for obtaining corresponding stereoscopic image resource files. The stereoscopic image resource files are also provided to the stereoscopic image display element 52 in order to calculate a series of stereoscopic images in real time based on the continuous actions.

It should be noted that, when the user performs an interaction through the stereoscopic image display element 52, an interaction instruction is generated. In the meantime, the stereoscopic image display element 52 (by a software process) can determine if the existing stereoscopic image resource files contain the display mode corresponding to the current interaction instruction. If it is determined that the existing stereoscopic image resource files already contain the display mode, the stereoscopic image display element 52 calculates the stereoscopic image data using the corresponding stereoscopic image resource file. Otherwise, if the existing stereoscopic image resource files do not contain the display mode, such as in step 711, the stereoscopic image display element 52 generates a request for obtaining a new stereoscopic image resource file to the stereoscopic image server 54. The stereoscopic image display element 52 then receives the new stereoscopic image resource file and accordingly calculates a new stereoscopic image.

### Embodiment 4

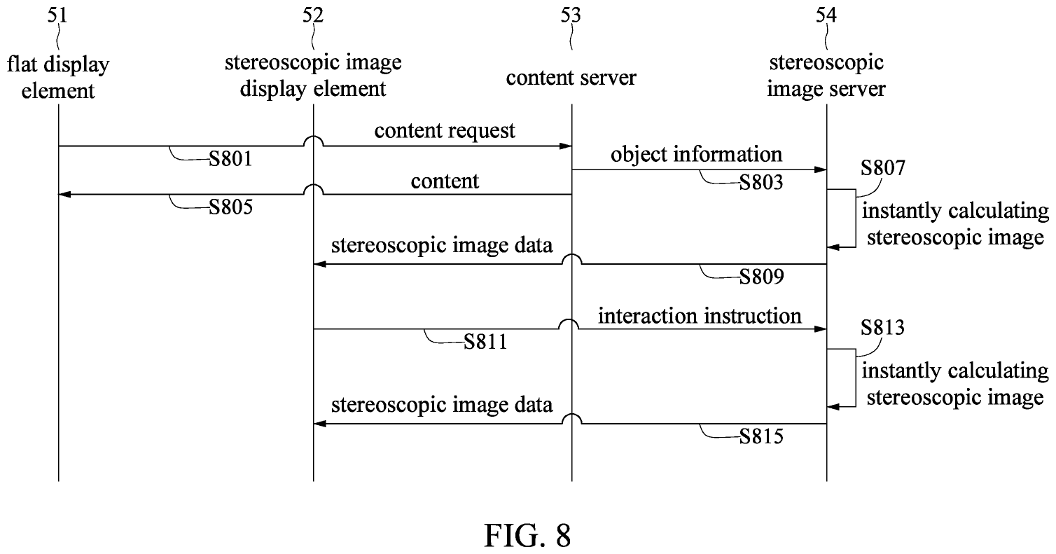

FIG. 8 shows a content server 53 acting as a shopping web site. The object in this aspect is such as a product exhibited on the web site or an advertisement embedded in the content. The stereoscopic image server 54 can calculate the stereoscopic image data according to the stereoscopic image resource file in real time. The stereoscopic image resource file can be provided by the content server 53 to the stereoscopic image server 54, or obtained from the image database of the stereoscopic image server 54.

In the beginning, the user manipulates the flat display element 51 to send a request to the content server 53 (step S801). As the user browses the content of the content server 53, a link with respect to an object is activated, and a request for displaying the object with the object information is transmitted to the stereoscopic image server 54 (step S803). Alternatively, rather than transmitting the object information to the server 54, the content server 53 can directly provide a stereoscopic image resource file with respect to the object in the request. On the other hand, the content server 53 responds to the user's request and provides the content to the flat display element 51 (step S05).

When the stereoscopic image server 54 receives the stereoscopic image resource file provided by the content server 53, a processor of the stereoscopic image server 54 is able to calculate the stereoscopic image in real time (step S807) so as to form the stereoscopic image data. The stereoscopic image data is then transmitted to the stereoscopic image display element 52 (step S809). The stereoscopic image display element 52 displays the stereoscopic image and also allows the user to perform an interaction. The interaction causes changes of the spatial coordinates of the stereoscopic image. Therefore, a status according to the changes of the stereoscopic image can be obtained. The interaction also generates an interaction instruction that is transmitted to the stereoscopic image server 54 (step S811). The stereoscopic image server 54 then calculates the stereoscopic image (step S813). Similarly, the stereoscopic image data is provided to the stereoscopic image display element 52 (step S815). The stereoscopic image data can be such as a stereoscopic image to be displayed.

In summation, according the above-described embodiments that depict the stereoscopic display method for displaying the various online objects, the stereoscopic image data is provided when the user views a flat content. With an E-commerce platform as an example, the platform not only provides conventional flat information when exhibiting various products, but also allows the user to select an article to activate a link of the article, and the stereoscopic image server then provides the related stereoscopic image data or the stereoscopic image resource file. Therefore, the user can instantly view the article or a relevant advertisement using a stereoscopic image. The stereoscopic display method and the system provide an innovative viewing experience for the user.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A stereoscopic display method for displaying an online object, comprising:
in a stereoscopic image server, receiving a request for displaying an object from a content server, and obtaining a requesting source corresponding to the request;
in the stereoscopic image server, generating a stereoscopic image data corresponding to the object; and
according to the requesting source, the stereoscopic image server transmitting the stereoscopic image data to a stereoscopic image display for displaying the object using a stereoscopic image.

2. The stereoscopic display method according to claim 1, wherein, in the stereoscopic image server, an image database is queried according to an identification data of the object when receiving the request for displaying object in order to obtain the stereoscopic image data corresponding to the object, and the stereoscopic image data provides data for the stereoscopic image display to display the stereoscopic image.

3. The stereoscopic display method according to claim 1, wherein, in the stereoscopic image server, an image database is queried according to an identification data of the object when receiving the request for displaying object, and the stereoscopic image data is a stereoscopic image resource file corresponding to the object, the stereoscopic image resource file being transmitted to the stereoscopic image display for calculating the stereoscopic image of the object.

4. The stereoscopic display method according to claim 3, wherein the stereoscopic image resource file includes a stereoscopic image description file and an environmental data file that are used to describe a static object or a moving object.

5. The stereoscopic display method according to claim 1, wherein, when the stereoscopic image server receives the request for displaying object, a stereoscopic image resource file corresponding to the object is also received, a processor of the stereoscopic image server calculates the stereoscopic image data in real time according to the stereoscopic image resource file, and the stereoscopic image data is provided for the stereoscopic image display to display the stereoscopic image of the object.

6. The stereoscopic display method according to claim 5, wherein the stereoscopic image resource file includes a stereoscopic image description file and an environmental data file that are used to describe a static object or a moving object.

7. The stereoscopic display method according to claim 1, wherein, when the stereoscopic image display displays a stereoscopic image of the object, the stereoscopic image server receives an interaction instruction generated by the stereoscopic image display; after that, the stereoscopic image server determines another display mode of the object according to the interaction instruction, and another corresponding stereoscopic image data is generated and transmitted to the stereoscopic image display in order to display the stereoscopic image in response to the interaction instruction.

8. The stereoscopic display method according to claim 7, wherein the content server provides a text, a picture or a video, and also a service for displaying the object in a stereoscopic image.

9. The stereoscopic display method according to claim 8, wherein the object is a product exhibited on a web page, the content server issues the request for displaying the object to the stereoscopic image server when a link with respect to the object is activated.

10. The stereoscopic display method according to claim 8, wherein the object is an advertisement shown on a web page, the content server issues the request for displaying the object to the stereoscopic image server when a link with respect to the object is activated as the web page is browsed.

11. A stereoscopic display system for displaying an online object, comprising:
a stereoscopic image server having an image database and connecting with a content server, used to provide stereoscopic image data according to a request for displaying an object generated by the content server; and
a stereoscopic image display used to receive the stereoscopic image data and display a stereoscopic image;
wherein the stereoscopic image server performs a stereoscopic display method for displaying the online object comprising:
in the stereoscopic image server, receiving the request for displaying the object from the content server, and obtaining a requesting source corresponding to the request;
in the stereoscopic image server, generating the stereoscopic image data corresponding to the object; and
according to the requesting source, the stereoscopic image server transmitting the stereoscopic image data to the stereoscopic image display for displaying the object using the stereoscopic image.

12. The stereoscopic display system according to claim 11, wherein, when the stereoscopic image display displays the stereoscopic image of the object, the stereoscopic image server receives an interaction instruction generated by the stereoscopic image display; after that, the stereoscopic image server determines another mode of the object according to the interaction instruction, and another corresponding stereoscopic image data is generated and transmitted to the stereoscopic image display in order to display the stereoscopic image in response to the interaction instruction.

13. The stereoscopic display system according to claim 11, wherein, in the stereoscopic image server, when the stereoscopic image server receives the request for displaying object, the image database is queried according to identification data of the object so as to obtain the stereoscopic image data of the object, and the stereoscopic image data is provided for the stereoscopic image display to display the stereoscopic image.

14. The stereoscopic display system according to claim 11, wherein, in the stereoscopic image server, when the stereoscopic image server receives the request for displaying the object, the image database is queried according to identification data of the object, the stereoscopic image data is a stereoscopic image resource file corresponding to the object, and the stereoscopic image resource file is transmitted to the stereoscopic image display that is used to calculate the stereoscopic image of the object using the stereoscopic image resource file.

15. The stereoscopic display system according to claim 11, wherein, when the stereoscopic image server receives the request for displaying object, a stereoscopic image resource file corresponding to the object is also received, a processor of the stereoscopic image server calculates the stereoscopic image data in real time according to the stereoscopic image resource file, and the stereoscopic image data is provided for the stereoscopic image display to display the stereoscopic image.

16. The stereoscopic display system according to claim 11, wherein the object is a product exhibited on a web page, the content server issues the request for displaying the object to the stereoscopic image server when a link with respect to the object is activated.

17. The stereoscopic display system according to claim 11, wherein the object is an advertisement shown on a web page, the content server issues the request for displaying the object to the stereoscopic image server when a link with respect to the object is activated as the web page is browsed.

18. The stereoscopic display system according to claim 17, wherein, when the stereoscopic image display displays the stereoscopic image of the object, the stereoscopic image server receives an interaction instruction generated by the stereoscopic image display; after that, the stereoscopic image server determines another mode of the object according to the interaction instruction, and another corresponding stereoscopic image data is generated and transmitted to the stereoscopic image display in order to display the stereoscopic image in response to the interaction instruction.

19. The stereoscopic display system according to claim 18, wherein, when the stereoscopic image display displays the stereoscopic image, a sensor of the stereoscopic image display senses a gesture, a voice command, or a touch command so as to generate the interaction instruction.

20. The stereoscopic display system according to claim 19, wherein, in the stereoscopic image display, the interaction instruction is generated when any of or any combination of a movement, a rotation and a zooming of the gesture is sensed by the sensor; and in the stereoscopic image server, the interaction instruction is used to obtain three-dimensional coordinates and vectors corresponding to a display space for generating a new stereoscopic image data.
